(19) United States
(12) Patent Application Publication
(10) Pub. No.: US 2024/0297522 A1
(43) Pub. Date: Sep. 5, 2024

(54) SYSTEM AND METHOD FOR AI-BASED PROGRAMMING OF BATTERY AGNOSTIC ENERGY STORAGE SYSTEM

(71) Applicant: BigBattery Inc, Chatsworth, CA (US)

(72) Inventors: Marshall Neipert, Chatsworth, CA (US); Xiao Ren Dong, Chatsworth, CA (US); XI Wang, Chatsworthc, CA (US); Eric C. Lundgren, Chatsworth, CA (US)

(21) Appl. No.: 18/116,490

(22) Filed: Mar. 2, 2023

(51) Int. Cl. H02J 7/00; G06N 20/00

(52) U.S. Cl. CPC H02J 7/0071; G06N 20/00; H02J 7/00047; H02J 7/0014; H02J 7/005; H02J 7/007182

(57) ABSTRACT

A system for a real time programming of a battery agnostic Battery Management System (BMS) including a processor of a BMS programming server node connected to a controller over a network and configured to host a machine learning (ML) module and a memory on which are stored machine-readable instructions that when executed by the processor, cause the processor to: receive sensory data from a sensor array attached to a battery module having a BMS coupled to the controller; parse the sensory data to derive a plurality of features; query a local BMS database to retrieve local historical BMS data collected from the battery module; generate a feature vector based on the plurality of features and the historical BMS data; and provide the feature vector to the ML module for generating a predictive model configured to output a BMS programming parameter for re-programming of the BMS.

### FIELD OF DISCLOSURE

The present disclosure generally relates to programming of energy storage systems, and more particularly, to an intelligent AI-based automated system for real-time programming of a high-voltage battery agnostic energy storage system based on predictive parameters.

### BACKGROUND

The number of Electric Vehicle (EV) batteries being manufactured is accelerating at an exponential pace. When the EV batteries no longer meet the high performance or capacity requirements for transportation or have some faulty components or cells within the pack, the pack is typically scrapped for recycling regardless of the remaining energy storage capability. The timing of EV adoption coincides with a high demand for green energy solutions. The cost of Photovoltaic (PV) and wind turbine derived energy is quite low, but requires relatively costly large capacity Energy Storage Systems (ESS) because sun and wind are not continuous sources. The battery costs of these ESS are hindering the growth of green energy adoption.

For lifespan and other reasons that will not be addressed herein, lithium batteries have proven to be the most advantageous solution of large ESS. Using newly manufactured batteries for ESS has advantages in that the batteries are likely of similar design and specifications. The major downside is the cost of newly manufactured lithium batteries and the limitations of servicing. The legacy ESS design wires lithium batteries in series to achieve the high voltages required for the efficiency demands of high-powered integrations. When batteries are in series, they must have similar capacities because the capacity of the series string is proportional to the weakest battery cell in the string.

Utilizing new lithium cells in series in a high-voltage Energy Storage Systems (ESS) has no initial performance concerns, however, over time the batteries will degrade at varying rates which causes large fluctuations in string capacities. As battery string series' capacities drop below minimum specifications of the ESS, the batteries are typically scrapped and recycled, regardless of the capacities of their peer cells. In other words, all batteries from the string series may be recycled which is inefficient.

Repurposing EV and other lithium batteries allows for a low cost and growing feedstock of energy storage. The repurposing allows for the remaining utilitarian value of their energy storage to be captured, which is a much higher value than the commodity value of the metals had they been recycled instead. Therefore, a need exists for an ESS with a design flexibility such that the batteries of different modular configurations never stop delivering energy even if some of the batteries are deactivated, and in that case, they can be easily replaced by a newer battery of different properties. However, existing systems offer no way of monitoring and reprogramming the battery of the string series in order to deactivate the individual defective batteries without complete loss of the operational capacity of the entire string series.

Accordingly, a system and method for an intelligent AI-based automated system for real-time programming of a high-voltage battery agnostic energy storage system based on predictive parameters are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for an intelligent AI-based automated prediction of programming parameters for the battery agnostic energy storage system. The system includes a processor of a Battery Management System (BMS) programming server node connected to a controller over a network and configured to host a machine learning (ML) module and a memory on which are stored machine-readable instructions that when executed by the processor, cause the processor to: receive sensory data from a sensor array attached to a battery module having a BMS coupled to the controller; parse the sensory data to derive a plurality of features; query a local BMS database to retrieve local historical BMS data collected from the battery module; generate a feature vector based on the plurality of features and the historical BMS data; and provide the feature vector to the ML module for generating a predictive model configured to output a BMS programming parameter for re-programming of the BMS.

Another embodiment of the present disclosure provides a method that includes one or more of: receiving sensory data from a sensor array attached to a battery module having a BMS coupled to the controller; parsing the sensory data to derive a plurality of features; querying a local BMS database to retrieve local historical BMS data collected from the battery module; generating a feature vector based on the plurality of features and the historical BMS data; and providing the feature vector to the ML module for generating a predictive model configured to output a BMS programming parameter for re-programming of the BMS.

Another embodiment of the present disclosure provides a computer-readable medium including instructions for receiving sensory data from a sensor array attached to a battery module having a BMS coupled to the controller; parsing the sensory data to derive a plurality of features; querying a local BMS database to retrieve local historical BMS data collected from the battery module; generating a feature vector based on the plurality of features and the historical BMS data; and providing the feature vector to the ML module for generating a predictive model configured to output a BMS programming parameter for re-programming of the BMS.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates functionality of hot swappable components of a high-voltage battery agnostic energy storage system consistent with the present disclosure;

FIG. 1B illustrates Battery Agnostic Energy Storage System (BAESS) blocks and racks parallel connections of the high-voltage battery agnostic energy storage system consistent with the present disclosure;

FIG. 1C illustrates a network diagram of a system for an intelligent AI-based automated programming of a high-voltage battery agnostic energy storage system consistent with the present disclosure;

FIG. 2 illustrates a network diagram of a system including detailed features of a battery agnostic battery management system (BMS) programming server node consistent with the present disclosure;

FIG. 3A illustrates a flowchart of a method for an intelligent AI-based automated programming of a high-voltage battery agnostic energy storage system consistent with the present disclosure;

FIG. 3B illustrates a further flow chart of a method for the intelligent AI-based automated programming of the a high-voltage battery agnostic energy storage system consistent with the present disclosure;

FIG. 4 illustrates a block diagram of a system including a computing device for performing the method of FIGS. 3A and 3B.

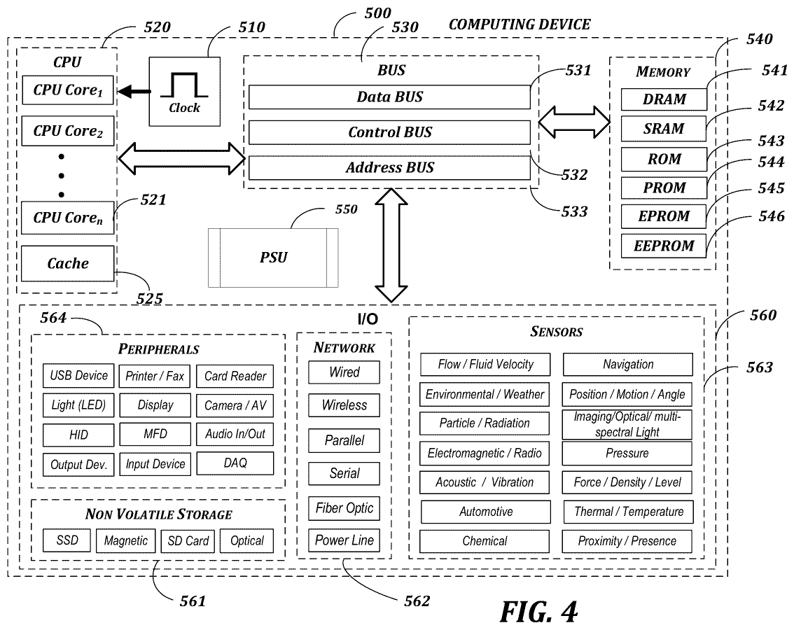

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of programming batteries and arrays of batterie connected in parallel, embodiments of the present disclosure are not limited to use only in this context.

The present disclosure provides a system, method and computer-readable medium for an intelligent AI-based automated real-time programming of a high-voltage battery agnostic energy storage system.

In one embodiment of the present disclosure, the system provides for AI and machine learning (ML)-generated list of BMS programming parameters to be used for re-configuration of BMSs of a battery module of the a high-voltage battery agnostic energy storage system. In one embodiment, an automated decision model may be generated to provide for identification of the most optimal settings of the BMSs based on the current sensory readings. The automated decision model may use historical battery usage and configuration data collected at the current battery module and at other battery modules of the same or similar type located within different high-voltage battery agnostic energy systems of similar topology.

In one disclosed embodiment, the AI/ML technology may be combined with a blockchain technology for secure use of the BMS configuration data. The disclosed embodiment may produce a detailed safety score on the battery failure likelihood at the current battery module based on the current reading of parameters of the battery within the battery module. This allows for direct reporting on a trust level of the particular battery module to an energy system authority or a user (i.e., technician).

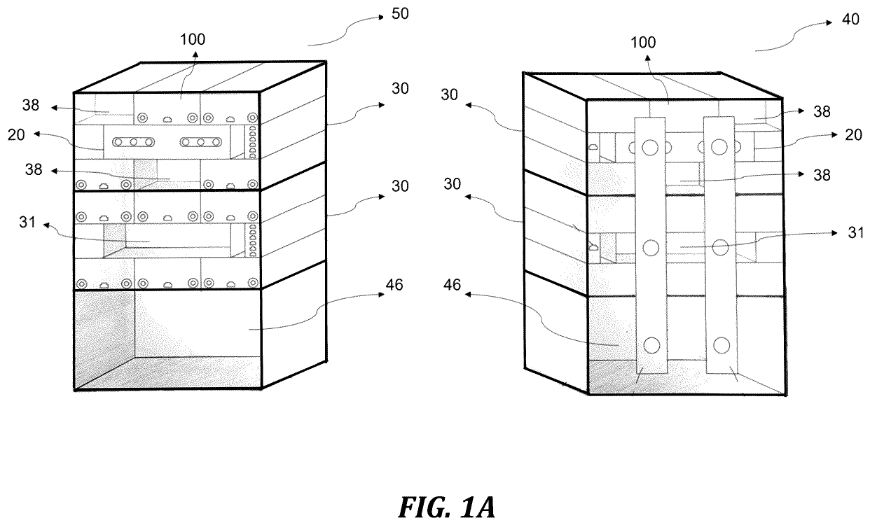

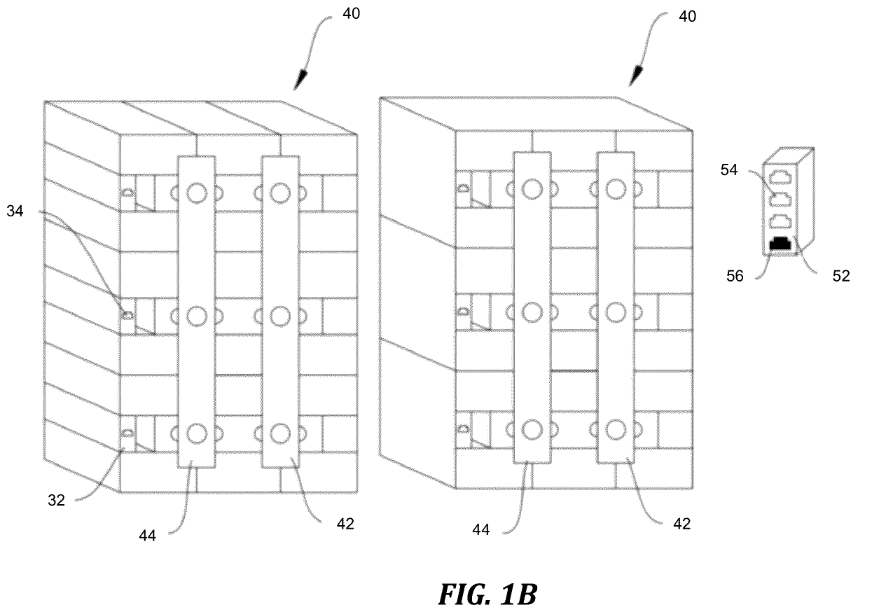

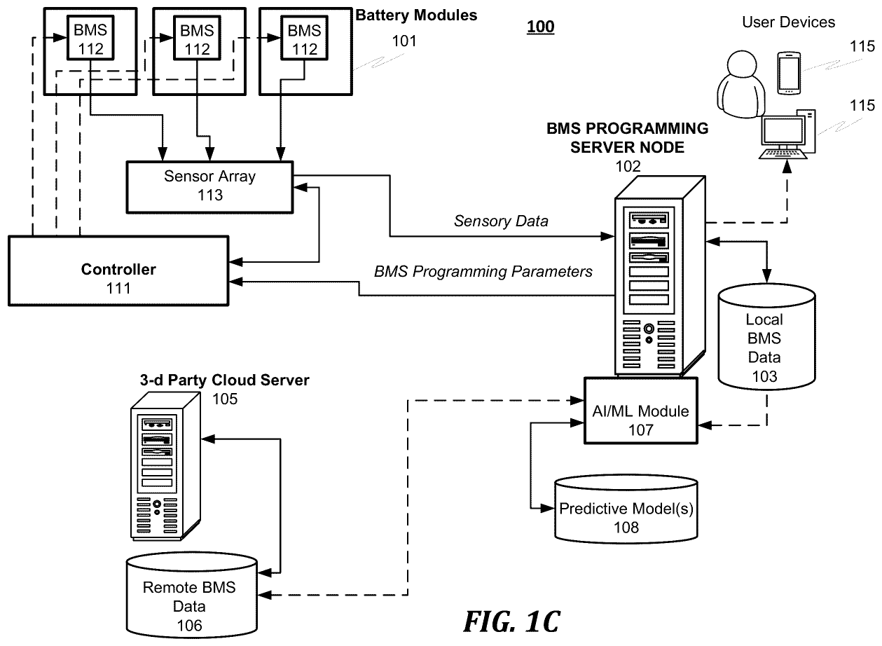

FIG. 1A illustrates functionality of hot swappable components of a high-voltage battery agnostic energy storage system consistent with the present disclosure.

Referring to a diagram depicted in FIG. 1, any battery 100 can be hot swapped from the Battery Agnostic Energy Storage System (BAESS) Block 30. If a battery 100 is removed from any Battery Sloth 38 of the BAESS Block 30, it will not affect the performance of the BAESS 40 because all the batteries 100 from every BAESS Block 30 are connected in parallel and the BAESS Block 30 will continue delivering the same amount of power. Battery Chemistry, Voltage, and Capacity have to be identical for all batteries 100 that belong to the same BAESS Block 30.

Any Voltage Booster 20 can be hot swapped from the BAESS Block 30. If a Voltage Booster 20 is removed from any Voltage Booster Sloth 31 of the BAESS Block 30, it will not affect the performance of the BAESS 40 because every BAESS Block 30 is advantageously connected in parallel. Although disconnecting the Voltage booster 20 from the BAESS Block 30 will stop the power delivery from that BAESS Block 30, the BAESS 40 will continue delivering the same amount of power thanks to the BAESS Blocks and Racks advantageous parallel connections.

Any Battery Agnostic Energy Storage System (BAESS) Block 30 can be hot swapped from any BAESS Rack 50. If a BAESS Block 30 is removed from any BAESS Block Sloth 46 of the BAESS Rack 50, it will not affect the performance of the BAESS, because every BAESS Block 30 is connected in parallel. Although disconnecting any BAESS Block 30 will reduce the energy (operating time) from that BAESS Block 30, the BAESS will continue delivering the same amount of power thanks to the BAESS Blocks and Racks advantageous parallel connections. Battery Chemistry, Voltage, and Capacity have to be identical for all batteries 100 that belong to the same BAESS Block 30, but these do not need to match other BAESS Blocks 30.

Any BAESS Rack 40 can be hot swapped from the BAESS 50. If a BAESS Rack 40 is removed from the BAESS 50, it will not affect the performance of the BAESS 50 because every BAESS Rack 40 is connected in parallel. Although disconnecting any BAESS Rack 40 will reduce the energy (operating time) from the BAESS 50, the BAESS 50 will continue delivering the same amount of power thanks to the BAESS Blocks and Racks parallel connections.

FIG. 1B illustrates Battery Agnostic Energy Storage System (BAESS) blocks and racks parallel connections of the high-voltage battery agnostic energy storage system consistent with the present disclosure.

FIG. 1B illustrates the BAESS in an oblique back view. Multiple racks 40 interconnected in parallel and connected to a BMS programming server node (not shown) form a Battery Agnostic Energy Storage System (BAESS). The BMS programming server node works using Artificial Intelligence (AI) to evaluate every Battery Module BMS Parameters. The BMS programming server node may be connected to the principal port 56 of the main communication switch 52. Every BAESS block 30 is connected to the BMS programming server by connecting the principal ports 34 of the block's communication switch 32 to the secondary ports 54 of the main communication switch 52.

The BMS programming server may host an AI/ML module that performs the following functions are: Evaluate battery behavior, Predict end of life, Calculate/Predict State of Health (SOH), Calculate/Predict State of Safety (SOS) using Temperature accumulation vs Current, and Temperature accumulation vs IR of every Battery Module 100. The BMS programming server may be configured to Record Temperature Values, Record Voltage Values, Record Current Values, Record SOC Values, Record IR Values, Calculate Capacity (Current vs Time), Record cycle by cycle Capacity (V), Record cycle by cycle Capacity (Ah), and to send Deactivation signal for the BMS when SOH or SOC are below specific threshold limits of every battery module 100 and BAESS block 30.

Every block 30 may be isolated from the BAESS system just by de-energizing the DC-DC voltage booster 20 by disconnecting the battery modules 100 from the voltage booster 20. If the AI/ML module identifies there is a failure in a block 30, or in a battery module 100, a controller will deactivate the BMS of the specific battery module 100 without stopping or affecting the performance and operation of the BAESS so a technician can swap the battery modules 100, DC-DC voltage booster 20, or any damaged component on each block without cessation of the operation of the block.

FIG. 1C illustrates a network diagram of a system for an intelligent AI-based automated programming of a BMS consistent with the present disclosure.

Referring to FIG. 1C, the example network 100 includes the BMS programming server node 102 connected to a 3-d party cloud server node(s) 105 over a network. The BMS programming server node 102 is configured to host an AI/ML module 107. The BMS programming server node may receive sensory data from an array of sensors 112 that may include, but not limited to: Temperature Value sensors, Voltage Values sensors, Current Values sensors, SOC Values sensors, IR Values sensors, sensor for outputting calculated Capacity (Current vs Time), sensor for cycle-by-cycle Capacity (V), sensor for cycle-by-cycle Capacity (Ah), etc.

Note that the array of sensors 112 may be located on the battery modules 101 or may be connected to the battery modules. The array of sensors 112 may be connected to the controller 111 for an immediate data exchange. The BMS programming server node 102 may query a local battery database for the historical battery BMS data 103 associated with the battery modules 101. The BMS programming server node 102 may acquire relevant remote battery BMS data 106 from a remote database residing on a 3-d party cloud server 105. The BMS data 106 may be collected from battery modules of the same (or similar) type located within a certain distance range of the current battery modules 101.

The BMS programming server node 102 may generate a feature vector data based on the sensory data and the collected BMS data (i.e., pre-stored local BMS data 103 and remote data 106). The BMS programming server node 102 may ingest the feature vector data into an AI/ML module 107. The AI/ML module 107 may generate a predictive model(s) 108 based on the feature vector data to predict programming parameters for automatically programming BMSs 112 of the battery modules 101. The programming parameters may be provided to a controller 111 operatively coupled to the battery modules 101. As discussed above, the controller 111 may be configured to send deactivation commands to the BMSs 112 if malfunction is detected. In one embodiment the controller 111 may receive a predictive output from the BMS programming server node 102 to generate a deactivation command for a particular BMS 112 after a certain time period has elapsed. In other words, the BMS programming server node 102 may predict the malfunction of the battery or another element based on the predictive outputs from the model(s) 108.

This way, the current BMS programming parameters may be predicted based not only on the live sensory data, but also based on the previously collected historical sensory and BMS-related data associated with the given battery module or another remote module of the similar topology.

In one embodiment, the BMSs 112 inputs may include cell's voltage, battery module voltage, battery module current, cell's internal resistance (ACIR), battery module temperature. The outputs of the BMSs 112 may include BMS initial parameters such as cell's chemistry, battery module initial capacity, and cell's configuration (i.e., series and parallel). Other monitored outputs may include cell's voltage, battery module voltage, battery module current, cell's internal resistance (ACIR), battery module temperature, real-time SOC and time.

In one embodiment, the outputs of the AI/ML module 107 of the BMS programming server node 102 may include End of Life prediction, State of Health (SOH), and State of Safety (SOS). In one embodiment, the SOS may be predicted based on temperature accumulation vs Current, and temperature accumulation vs IR.

The controller 111 may produce a command (signal) for activation/deactivation of a BMS 112 based on the outputs of the AI/ML module 107—i.e., when SOH and/or SOC are below specific threshold limits. Simultaneously, a notification may be sent to a user (i.e., a technician) device 115 so he can remover or swap the deactivate elements of the battery module 101. The historical BMS data such as voltage, current, capacity, temperature, SOC and IR may be recorded in the database 103 for training of the model(s) 108.

In one embodiment, the battery modules 101 may use hot swappable batteries (not shown) that may be connected in parallel at different States of Charge without pre-balancing. The BMSs 112 may have a hot swappable mode that activates a current limiter function. The current limiter keeps down the rush of current until the difference in voltage drops below a preset threshold. Then, the BMSs 112 may automatically go into normal operation mode.

In another embodiment, the system may use the battery modules 101 that only require batteries of matching chemistry and series. However, the proposed battery modules 101 may not require the batteries to match in capacity, state of health, form factor, or specified discharge rate. This functionality may be implemented by a remotely programmable BMSs 112 with a current limiter that provides for the operation of batteries based on their individual capabilities and ensures that no battery is overloaded.

In yet another embodiment, the system may use battery modules 101 that allow batteries of different chemistry and series groups to work together by using programmable and tunable Boosters (not shown). The boosters may be tuned to match voltage so they can be paralleled at high voltage.

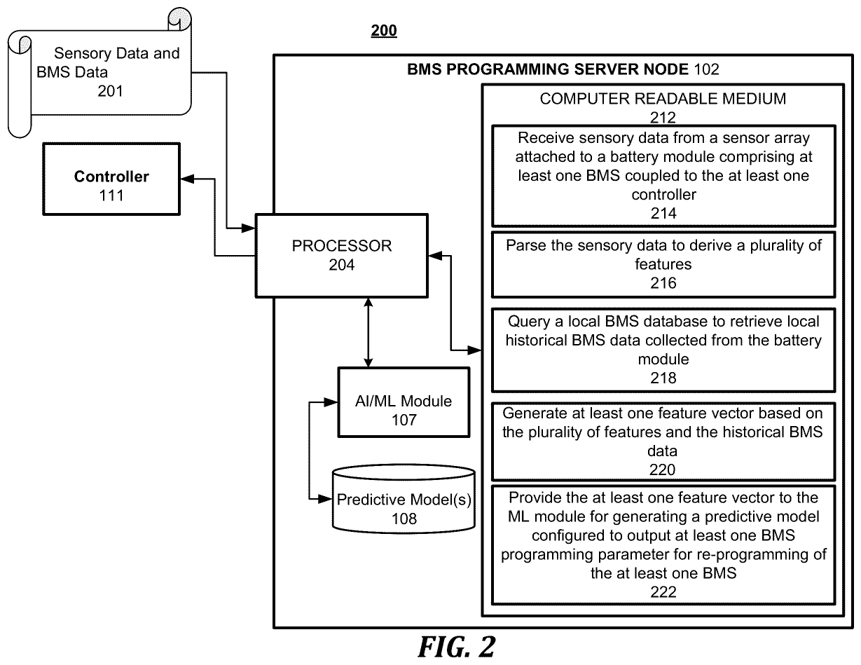

FIG. 2 illustrates a network diagram of a system including detailed features of a BMS programming server node consistent with the present disclosure.

Referring to FIG. 2, the example network 200 includes the BMS programming server node 102 connected to a controller 111 over a network (LAN or wireless). The BMS programming server node 102 is configured to host an AI/ML module 107. As discussed above with reference to FIGS. 1C, the BMS programming server node 102 may receive sensory data acquired from sensor array 113 and pre-stored historical battery data retrieved from local and remote databases. As discussed above, the pre-stored historical battery data may be retrieved from the ledger of a blockchain (not shown).

The AI/ML module 107 may generate a predictive model(s) 108 based on the received sensory data 201 and BMS-related data provided by the BMS programming server node 102. As discussed above, the AI/ML module 107 may provide predictive outputs data in a form of programming parameters for automatic re-programming of the BMSs 112 (FIG. 1C) by the controller 111. The BMS programming server node 102 may process the predictive outputs data received from the AI/ML module 107 to generate a list of BMS programming parameters.

In one embodiment, the BMS programming server node 102 may periodically receive readings from sensors of the sensor array 113. In another embodiment, the BMS programming server node 102 may continually monitor readings from the sensors of the sensor array 113 and may detect a reading that deviates from a previous reading (or from a median reading value) by a margin that exceeds a threshold value pre-set for this particular reading. For example, if a certain battery parameter drops by more than 30%, this may cause poor functionality of the respective battery module 101 (FIG. 1C). Accordingly, once the threshold is met or exceeded by at least one sensor reading (i.e., sensory data), the BMS programming server node 102 may provide the currently acquired readings to the AI/ML module 107 to generate a list of updated programming parameters based on the current readings. Subsequently the programming parameters may be provided to the controller configured to send deactivation command to the BMS that are deemed to be malfunctioning or are about to fail after a certain time period.

While this example describes in detail only one BMS programming server node 102, multiple such nodes may be connected to the network. It should be understood that the BMS programming server node 102 may include additional components and that some of the components described herein may be removed and/or modified without departing from a scope of the BMS programming server node 102 disclosed herein. The BMS programming server node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the BMS programming server node 102 may include multiple processors, multiple cores, or the like, without departing from the scope of the BMS programming server node 102 system.

The BMS programming server node 102 may also include a non-transitory computer readable medium 212 that may have stored thereon machine-readable instructions executable by the processor 204. Examples of the machine-readable instructions are shown as 214-222 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to receive sensory data from a sensor array 113 attached to a battery module comprising at least one BMS 112 coupled to the at least one controller 111. The processor 204 may fetch, decode, and execute the machine-readable instructions 216 to parse the sensory data to derive a plurality of features. The processor 204 may fetch, decode, and execute the machine-readable instructions 218 to query a local BMS database 103 to retrieve local historical BMS data collected from the battery module 101. The processor 204 may fetch, decode, and execute the machine-readable instructions 220 to generate at least one feature vector based on the plurality of features and the historical BMS data.

The processor 204 may fetch, decode, and execute the machine-readable instructions 222 to provide the at least one feature vector to the ML module 107 for generating a predictive model 108 configured to output at least one BMS programming parameter for re-programming of the at least one BMS 112.

In one embodiment, the controller 111 may provide multiple analog-to-digital inputs. Therefore, the voltage is actively monitored to ensure the voltage does not exceed a predetermined limit. If that limit is exceeded, the controller 111 can quickly respond (typically within microseconds) and turn off all outputs until the fault condition is automatically corrected as follows.

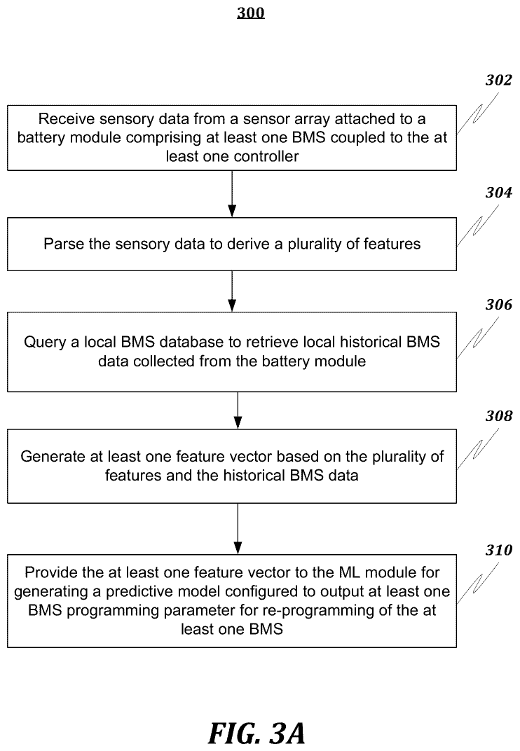

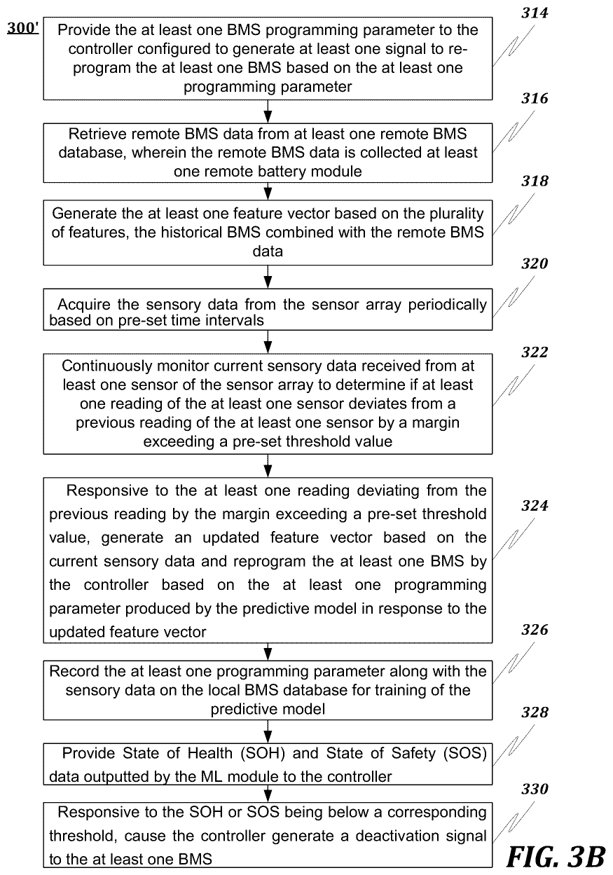

FIG. 3A illustrates a flowchart of a method for an intelligent AI-based automated programming of a BMS consistent with the present disclosure.

Referring to FIG. 3A, the method 300 may include one or more of the steps described below. FIG. 3A illustrates a flow chart of an example method executed by the BMS programming server node 102 (see FIG. 2). It should be understood that method 300 depicted in FIG. 3A may include additional operations and that some of the operations described therein may be removed and/or modified without departing from the scope of the method 300. The description of the method 300 is also made with reference to the features depicted in FIG. 2 for purposes of illustration. Particularly, the processor 204 of the BMS programming server node 102 may execute some or all of the operations included in the method 300.

With reference to FIG. 3A, at block 302, the processor 204 may receive sensory data from a sensor array attached to a battery module comprising at least one BMS coupled to the at least one controller. At block 304, the processor 204 may parse the sensory data to derive a plurality of features. At block 306, the processor 204 may query a local BMS database to retrieve local historical BMS data collected from the battery module. At block 308, the processor 204 may generate at least one feature vector based on the plurality of features and the historical BMS data. At block 310, the processor 204 may provide the at least one feature vector to the ML module for generating a predictive model configured to output at least one BMS programming parameter for re-programming of the at least one BMS.

FIG. 3B illustrates a further flowchart of a method for an intelligent AI-based automated programming of a BMS consistent with the present disclosure. Referring to FIG. 3B, the method 300′ may include one or more of the steps described below. FIG. 3B illustrates a flow chart of an example method executed by the BMS programming server node 102 (see FIG. 2). It should be understood that method 300′ depicted in FIG. 3B may include additional operations and that some of the operations described therein may be removed and/or modified without departing from the scope of the method 300′. The description of the method 300′ is also made with reference to the features depicted in FIG. 2 for purposes of illustration. Particularly, the processor 204 of the BMS programming server node 102 may execute some or all of the operations included in the method 300′.

With reference to FIG. 3B, at block 314, the processor 204 may provide the at least one BMS programming parameter to the controller configured to generate at least one signal to re-program the at least one BMS based on the at least one programming parameter. At block 316, the processor 204 may retrieve remote BMS data from at least one remote BMS database, wherein the remote BMS data is collected at least one remote battery module. At block 318, the processor 204 may generate the at least one feature vector based on the plurality of features, the historical BMS combined with the remote BMS data. At block 320, the processor 204 may acquire the sensory data from the sensor array periodically based on pre-set time intervals. At block 322, the processor 204 may continuously monitor current sensory data received from at least one sensor of the sensor array to determine if at least one reading of the at least one sensor deviates from a previous reading of the at least one sensor by a margin exceeding a pre-set threshold value. At block 324, the processor 204 may, responsive to the at least one reading deviating from the previous reading by the margin exceeding a pre-set threshold value, generate an updated feature vector based on the current sensory data and reprogram the at least one BMS by the controller based on the at least one programming parameter produced by the predictive model in response to the updated feature vector. At block 326, the processor 204 may record the at least one programming parameter along with the sensory data on the local BMS database for training of the predictive model. At block 328, the processor 204 may provide State of Health (SOH) and State of Safety (SOS) data outputted by the ML module to the controller. At block 330, the processor 204 may responsive to the SOH or SOS being below a corresponding threshold, cause the controller generate a deactivation signal to the at least one BMS. The BMS programming server 102 may send a notification to a user device responsive to the SOH or SOS being below the corresponding threshold.

In one disclosed embodiment, the programming parameters' model may be generated by the AI/ML module 107 that may use training data sets to improve accuracy of the prediction of the programming parameters for the controller 111 (FIG. 2). The programming parameters used in training data sets may be stored in a centralized local database (such as one used for storing local historical battery data 103 depicted in FIG. 1C). In one embodiment, a neural network may be used in the AI/ML module 107 for BMS modeling and re-programming predictions.

In another embodiment, the AI/ML module 107 may use a decentralized storage such as a blockchain (not shown) that is a distributed storage system, which includes multiple nodes that communicate with each other. The decentralized storage includes an append-only immutable data structure resembling a distributed ledger capable of maintaining records between mutually untrusted parties.

After the model has been trained, it may be deployed to a live environment where it can make BMS programming predictions/decisions based on the execution of the final trained machine learning model using the programming parameters. In this example, data fed back from the BMSs may be input into the machine learning model and may be used to make new programming predictions such as most optimal programming parameters for re-programming of the BMSs by the controller. Determinations made by the execution of the machine learning model (e.g., programming parameters, etc.) may be stored on the blockchain ledger to provide auditable/verifiable proof.

The above embodiments of the present disclosure may be implemented in hardware, in a computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 5 illustrates an example computing device (e.g., a server node) 500, which may represent or be integrated in any of the above-described components, etc.

FIG. 5 illustrates a block diagram of a system including computing device 500. The computing device 500 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS500/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;
The BMS programming server node 102 (see FIG. 2) may be hosted on a centralized server or on a cloud computing service. Although method 300 has been described to be performed by the BMS programming server node 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 550, a power supply unit (PSU) 550, and one or more Input/Output (I/O) units. The CPU 520 coupled to the memory unit 550 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 520, the bus 530, the memory unit 550, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 550 may be implemented with computing device 500 or any of other computing devices 500, in combination with computing device 500. The aforementioned system, device, and components are examples and other systems, devices, and components may comprise the aforementioned CPU 520, the bus 530, the memory unit 550, consistent with embodiments of the disclosure.

At least one computing device 500 may be embodied as any of the computing elements illustrated in all of the attached figures, including the design server node 102 (FIG. 2). A computing device 500 does not need to be electronic, nor even have a CPU 520, nor bus 530, nor memory unit 550. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 550, at least one PSU 550, and at least one I/O 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 550 or input/output 560). Some embodiments of the clock 510 may include dynamic frequency change, where, the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 550, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, know to the person having ordinary skill in the art as primary storage or memory 550. The memory 550 operates at high speed, distinguishing it from the non-volatile storage sub-module 561, which may be referred to as secondary or tertiary storage, which provides slow-to-access information but offers higher capacities at lower cost. The contents contained in memory 550, may be transferred to secondary storage via techniques such as, but not limited to, virtual memory and swap. The memory 550 may be associated with addressable semiconductor memory, such as integrated circuits consisting of silicon-based transistors, used for example as primary storage but also other purposes in the computing device 500. The memory 550 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 551, Static Random-Access Memory (SRAM) 552, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 553, Programmable ROM (PROM) 555, Erasable PROM (EPROM) 555, Electrically Erasable PROM (EEPROM) 556 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by the at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using intermediate area in the memory 550. The non-volatile storage sub-module 561 does not lose data when power is removed and may be two orders of magnitude less costly than storage used in memory module, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be said are networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 5G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (02), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LIDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices uses to put information into and get information out of the computing device 500. There are 3 categories of devices comprising the peripheral sub-module 565, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 565:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for an automated programming of a battery agnostic battery management system (BMS), comprising:
a processor of a BMS programming server node connected to at least one controller over a network and configured to host a machine learning (ML) module;
a memory on which are stored machine-readable instructions that when executed by the processor, cause the processor to:
receive sensory data from a sensor array attached to a battery module comprising at least one BMS coupled to the at least one controller;
parse the sensory data to derive a plurality of features;
query a local BMS database to retrieve local historical BMS data collected from the battery module;
generate at least one feature vector based on the plurality of features and the historical BMS data; and
provide at least one feature vector to the ML module for generating a predictive model configured to output at least one BMS programming parameter for re-programming of the at least one BMS.

2. The system of claim 1, wherein the instructions further cause the processor to provide the at least one BMS programming parameter to the controller configured to generate at least one signal to re-program the at least one BMS based on the at least one programming parameter.

3. The system of claim 1, wherein the instructions further cause the processor to retrieve remote BMS data from at least one remote BMS database, wherein the remote BMS data is collected at least one remote battery module.

4. The system of claim 3, wherein the instructions further cause the processor to generate the at least one feature vector based on the plurality of features, the historical BMS combined with the remote BMS data.

5. The system of claim 1, wherein the instructions further cause the processor to acquire the sensory data from the sensor array periodically based on pre-set time intervals.

6. The system of claim 1, wherein the instructions further cause the processor to continuously monitor current sensory data received from at least one sensor of the sensor array to determine if at least one reading of the at least one sensor deviates from a previous reading of the at least one sensor by a margin exceeding a pre-set threshold value.

7. The system of claim 6, wherein the instructions further cause the processor to, responsive to the at least one reading deviating from the previous reading by the margin exceeding a pre-set threshold value, generate an updated feature vector based on the current sensory data and reprogram the at least one BMS by the controller based on the at least one programming parameter produced by the predictive model in response to the updated feature vector.

8. The system of claim 1, wherein the instructions further cause the processor to record the at least one programming parameter along with the sensory data on the local BMS database for training of the predictive model.

9. The system of claim 1, wherein the instructions further cause the processor to provide State of Health (SOH) and State of Safety (SOS) data outputted by the ML module to the controller.

10. The system of claim 9, wherein the instructions further cause the processor to, responsive to the SOH or SOS being below a corresponding threshold, cause the controller generate a deactivation signal to the at least one BMS.

11. The system of claim 10, wherein the instructions further cause the processor to send a notification to a user device responsive to the SOH or SOS being below the corresponding threshold.

12. The system of claim 1, further comprising:
the battery module configured to use a plurality of hot swappable batteries connected in parallel at different states of charge without pre-balancing;
the BMS configured to use a hot swappable mode for activation of a current limiter function configured to keeps down a flow of current until a difference in voltage at the plurality of hot swappable batteries drops below a preset threshold.

13. The system of claim 1, further comprising a remotely programmable BMS with a current limiter configured to use batteries of matching chemistry and series, wherein the batteries comprising unmatched parameters of:
capacities;
state of health;
form factor; and
discharge rate.

14. The system of claim 1, further comprising a plurality of programmable tunable boosters configured to provide for simultaneous operation of batteries of different chemistry and series groups, wherein the programmable tunable boosters are further configured to be tuned to match voltage at the batteries to accommodate paralleled arrangement of the batteries at high voltage.

15. A method for an automated programming of a battery agnostic battery management system (BMS), comprising:
receiving, by a BMS programming server configured to host a machine learning (ML) module, sensory data from a sensor array attached to a battery module comprising at least one BMS coupled to at least one controller;
parsing, by the BMS programming server, the sensory data to derive a plurality of features;
querying, by the BMS programming server, a local BMS database to retrieve local historical BMS data collected from the battery module;
generating, by the BMS programming server, at least one feature vector based on the plurality of features and the historical BMS data; and
providing the at least one feature vector to the ML module for generating a predictive model configured to output at least one BMS programming parameter for re-programming of the at least one BMS.

16. The method of claim 15, further comprising providing the at least one BMS programming parameter to the controller configured to generate at least one signal to re-program the at least one BMS based on the at least one programming parameter.

17. The method of claim 15, further comprising retrieving remote BMS data from at least one remote BMS database, wherein the remote BMS data is collected at least one remote battery module.

18. The method of claim 17, further comprising generating the at least one feature vector based on the plurality of features, the historical BMS combined with the remote BMS data.

19. The method of claim 15, further comprising continuously monitoring current sensory data received from at least one sensor of the sensor array to determine if at least one reading of the at least one sensor deviates from a previous reading of the at least one sensor by a margin exceeding a pre-set threshold value.

20. A non-transitory computer readable medium comprising instructions, that when read by a processor, cause the processor to perform:
receiving sensory data from a sensor array attached to a battery module comprising at least one BMS coupled to at least one controller;
parsing the sensory data to derive a plurality of features;
querying a local BMS database to retrieve local historical BMS data collected from the battery module;
generating at least one feature vector based on the plurality of features and the historical BMS data; and
providing the at least one feature vector to an ML module for generating a predictive model configured to output at least one BMS programming parameter for re-programming of the at least one BMS.
